(19) United States
(12) Patent Application Publication
(10) Pub. No.: US 2002/0167869 A1
(43) Pub. Date: Nov. 14, 2002

(54) Position detecting apparatus and timepiece hand position detecting apparatus using the same

(76) Inventors: Shigeyuki Masuda, Chiba-shi (JP); Takanori Hasegawa, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/134,169

(22) Filed: Apr. 26, 2002

(30) Foreign Application Priority Data
May 11, 2001 (JP) 2001-142141

(51) Int. Cl. G04B 19/04

(52) U.S. Cl. 368/238

(57) ABSTRACT

To provide a position detecting apparatus capable of promoting detection certainty of a position of a movable body, a hand position detecting apparatus of a timepiece capable of promoting detection certainty of a position of a hand and an electronic timepiece having the hand position detecting apparatus. Hand position detecting apparatus of an electronic timepiece include movable bodies constituted by integrally molding conductive portions including conductive carbon nanotube and nonconductive portions including nonconductive carbon nanotube, and probes for detecting that either ones of the conductive portions and the nonconductive portions of the movable bodies are present at detected regions.

### BACKGROUND OF THE INVENTION

1. Field of the Invention:

The present invention relates to a position detecting apparatus, more in details, relates to a position detecting apparatus suitable for being used in a hand position detecting apparatus of a timepiece or the like.

2. Description of the Prior Art:

In various kinds of analog type (hand type) timepieces, it is not seldom desired to set or position a hand to a reference position, that is, a zero position or an initial position. For example, what corresponds thereto is forcibly setting a hand of a stop watch to a zero position before starting to count time or a case in which in a radio wave type timepiece capable of adjusting time by detecting radio wave including time information, a position of a hand of the timepiece is typically set to a position in accordance with the time information based on the time information of radio wave (for example, 12 o'clock 00 minute 00 second etc.). For setting such a hand position, according to this kind of a timepiece, normally, there are provided a fast feeding mechanism for fast feeding a hand forcibly and a hand portion detecting apparatus capable of detecting that the hand reaches a specific rotational position (for example, zero position). More in details, according to the conventional timepiece of this kind, typically, for example, there is constructed a constitution in which a leaf spring made of a metal is fixed to a second wheel fixed to a second pinion attached with a second hand and an extended end of the leaf spring is brought into press contact with a surface of a circuit board and when the leaf spring rotated along with the second hand and the second wheel is brought into contact with a pad portion or a contact portion formed at the surface of the circuit board, it is detected that the second hand reaches an initial position.

However, according to this kind of the conventional hand position detecting mechanism, the wheel (for example, second wheel) typically having a diameter of about 3 mm and a thickness of about 0.2 mm, is fixed with the leaf spring separately formed from the wheel and therefore, there is a concern that play is caused between the leaf spring and the wheel, relative positions of the leaf spring and the wheel are shifted from each other, relative positions of the leaf spring and (for example) the second hand are shifted from each other and certainty of detecting position of the second hand is deteriorated.

Meanwhile, it has been found that conductivity of carbon nanotube is changed in accordance with a diameter or a chiral angle (spiral angle) thereof, further, owing to a structure thereof, high mechanical strength (rupture strength or rigidity) or the like is expected and its use is beginning to be investigated.

The invention has been carried out in view of the above-described various points and it is an object thereof to provide a position detecting apparatus capable of promoting a certainty of detecting a position of a movable body.

### SUMMARY OF THE INVENTION

It is other object of the invention to provide a hand position detecting apparatus of a timepiece capable of promoting a certainty of detecting a position of a hand and an electronic timepiece having the hand position detecting apparatus.

In order to achieve the above-described objects, according to the invention, there is provided a position detecting apparatus comprising a movable body constituted by integrally molding a conductive portion including a conductive carbon nanotube and a nonconductive portion including a nonconductive carbon nanotube, and a probe for detecting that either one portion of the conductive portion and the nonconductive portion of the movable body is present at a detected region.

The position detecting apparatus of the invention is provided with “a probe for detecting that either one portion of the conductive portion and the nonconductive portion of the movable body is present at a detected region, the expression including passing the detected region” and therefore, a state of moving the movable body can be detected by the probe.

Further, according the position detecting apparatus of the invention, “a conductive portion of the movable member includes a conductive carbon nanotube and a nonconductive portion thereof includes a nonconductive carbon nanotube” and therefore, the conductive portion and the nonconductive portion can actually be constituted by the same or similar material macroscopically. Therefore, “the movable body constituted by integrally molding the conductive portion and the nonconductive portion” can be regarded to substantially comprise the same material as a whole and therefore, in comparison with, for example, a case of dispersing conductive metal powder or the like to a rein only at a conductive portion, in integral molding, the nonconductive portion and the nonconductive portion can solidly be integrated or bonded. Further, macroscopically, carbon nanotube can adopt, for example, a mode of fine powder and therefore, when the carbon nanotube is dispersed in a resin or the like, the carbon nanotube can be dispersed uniformly and therefore, in each of the conductive portion and the nonconductive portion, a substantially uniform or equal composition can easily be realized. As a result, in the movable body, solid integration of the conductive portion and the nonconductive portion is easy to realize. Therefore, there is hardly a concern of causing a shift in relative positions of the conductive portion and the nonconductive portion and detection of positions of the conductive portion or the nonconductive portion can amount to detection of the position of the movable body with high certainty. Further, so far as the solid integration of the conductive portion and the nonconductive portion can be ensured, when desired, carbon nanotube maybe dispersed nonuniformly at at least either portion of the conductive portion and the nonconductive portion.

Further, with regard to the movable body, the “nonconductive portion” signifies “that conductivity is low to an identifiable degree in comparison with that of the conductive portion”. Therefore, when the conductive portion is provided with a metallic conductive performance or conductive degree, the nonconductive portion typically comprises so-to-speak insulator having high electric insulating performance, however, depending on cases, the nonconductive portion may be semiconductive (typically, semiconductive conductive property and conductive degree). Further, when the nonconductive portion comprises a plurality of regions remote from each other, all of the regions may comprise a similar constitution or one or a plurality of regions may comprise constitutions different from each other. Meanwhile, when the nonconductive portion is provided with semiconductivity, the nonconductive portion typically comprises an insulator. Further, so far as the two portions differ from each other to an identifiable degree with regard to the conductivity, depending on cases, the two portions may be provided with conductivities normally referred to as metallic, or the two portions may be provided with nonconductivities (insulating performances) normally referred to as electric insulating performances, or the two portions may be provided with semiconductivities normally. Further, when the conductive portion is constituted by a plurality of regions remote from each other, all of the regions may comprise a substantially similar constitution or a single or a plurality of regions may comprise constitutions different from each other.

Although the conductive portion and the nonconductive portion may be distributed in any way in the movable body so far as the conductive portion and the nonconductive portion can be identified by a probe, typically, the conductive portion includes a surface portion constituting a portion of a surface of the movable member capable of being opposed to the probe and the nonconductive portion includes a surface portion constituting a portion of the surface of the movable body capable of being opposed to the probe.

Further, according to the position detecting apparatus of the invention, “the movable body is integrally provided with the conductive portion and the nonconductive portion” and therefore, the probe may be any detecting means so far as the probe can detect whether the conductive portion or the nonconductive portion of the movable body is present in the detected region. That is, so far as the conductive portion and the nonconductive portion can be identified, the position detecting apparatus may be of a type (contact type) identifying the conductive portion and the nonconductive portion by bringing a front end or the like of the probe into contact with the surface of the movable body, or may be of a type (noncontact type) in which a front end or the like of the probe is opposed to a region (detected region) of the movable body detected by the probe with a gap therebetween for identifying the conductive portion and the nonconductive portion, further, mutual operation or principle with regard to detection may be of any of electric, optical, electromagnetic ormagnetic type or system. Further, with regard to the probe, a constitution of “detecting that either one portion of the conductive portion and the nonconductive portion of the movable body is present at the detected region”, is not limited to a constitution for detecting “existence” or “existence or nonexistence”, that is, “presence or absence” of the conductive portion or the nonconductive portion in the detected region but may include a constitution for detecting that the conductive portion or the nonconductive portion passes through the detected region. In the latter case, there may be constructed a constitution for detecting that the conductive portion or the nonconductive portion enters from outside of the detected region to inside of the detected region, a constitution for detecting that the conductive portion or the nonconductive portion is passing through the detected region, or a constitution for detecting that the conductive portion or the nonconductive portion comes out from inside of the detected region to outside of the detected region, or a constitution for detecting that the conductive portion or the nonconductive portion enters from outside of the detected region to inside of the detected region and thereafter comes out to outside of the detected region. Further, although the probe is typically of a type of detecting that the “conductive portion” is present in the detected region, the probe may be of a type of detecting that the “nonconductive portion” is present in the detected region instead of the “conductive portion”.

Further, although most of carbon nanotube included in the conductive portion typically comprises conductive carbon nanotube, so far as the conductivity of the conductive portion is sufficiently higher than that of the nonconductive portion, a portion or a corresponding portion of carbon nanotube included in the conductive portion may relatively nonconductive. Although a rate of the corresponding portion is typically equal to or smaller than, for example, about 50%, depending on cases, the rate may exceed about 50%. Further, substantially a total of carbon nanotube included in the conductive portion may comprise conductive carbon nanotube. Further, the conductive region may simultaneously be blended or mixed with a substance other than carbon nanotube.

Similarly, although most of carbon nanotube included in the nonconductive portion typically comprises nonconductive carbon nanotube, so far as the conductivity of the nonconductive portion is sufficiently lower than that of the conductive portion, a portion or a corresponding portion of carbon nanotube included in the nonconductive portion may relatively be conductive. Although a rate of the corresponding portion is typically equal to or smaller than about 50%, depending on cases, the rate may exceed 50%. Further, substantially a total of carbon nanotube included in the nonconductive portion may comprise nonconductive carbon nanotube. Further, the nonconductive region may simultaneously be blended or mixed with a substance other than carbon nanotube.

With regard to carbon nanotube, the conductivity or the nonconductivity refers to a case of being conductive or nonconductive with regard to the region of the movable body, or similarly, refers to that in view of the conductivity, the conductivity is high or low relatively to an identifiable degree, typically, conductive carbon nanotube indicates carbon nanotube having metallic conductivity and nonconductive carbon nanotube indicates carbon nanotube having comparatively high electric insulating performance as in a semiconductive or an insulator having a comparatively large band gap.

Further, the fact per se that a carbon nanotube is conductive or nonconductive in accordance with a diameter or a chiral angle (spiral degree) thereof, is well known. The conductive carbon nanotube may comprise a component having a constant diameter or chiral angle, or may be mixed with components having different diameters or chiral angles so far as the conductive carbon nanotube is provided with a conductivity sufficiently larger than that of the nonconductive carbon nanotube. Further, the diameter or the like of the respective carbon nanotube per se may not be constant. Similarly, a nonconductive carbon nanotube may comprise a component having a constant diameter or chiral angle or may be mixed with components having different diameters and chiral angles so far as the nonconductive carbon nanotube is provided with a conductivity sufficiently smaller than that of a conductive carbon nanotube. Although it is preferable that a length of the carbon nanotube is comparatively short macroscopically to be dispersed uniformly, the length may comparatively be long so far as a resin or the like operated as a base material can disperse the carbon nanotube sufficiently uniformly or equally. Further, in order to make coupling of the carbon nanotubes (including intertwinement) solid, depending on cases, the length may comparatively be long.

Although the carbon nanotube typically comprises so-to-speak single layer nanotube, the carbon nanotube may comprise plural layers or may be mixed with single layers and plural layers so far as a desired conductive property can be provided. Further, although the carbon nanotube typically comprises only carbon, depending on cases, an atom other than carbon may be interposed at inside or surface of the nanotube or between the tubes.

The nonconductive main body portion and the conductive portion of the movable body is typically constituted by dispersing carbon nanotubes having different conductivities at different regions or portions of the same resin. That is, typically, there are separately prepared a conductive resin material (when the conductive portion comprises a plurality of kinds of secondary conductive portions, a single kind or plural kinds of conductive resin materials in accordance with the kinds) constituted by dispersing a conductive carbon nanotube to a resin material uniformly by a desired rate and, a nonconductive resin material (when the nonconductive main body portion comprises a plurality of kinds of secondary nonconductive portions, a single kind or plural kinds of nonconductive resin materials in accordance with the kinds) constituted by dispersing a nonconductive carbon nanotube to a resin material uniformly by a desired rate and, for example, by so-to-speak two colors or multiple colors injection molding, the conductive main body portion (region) and the nonconductive portion (region) having a desired pattern are formed and integrally molded. Further, two colors or multiple colors injection molding technology per se of resin is well known (for example, refer to “first chapter 1.5.6 two colors (multiple colors) injection molding method” in “injection molding die mold machine 7” (Japan Institute of Invention & Innovation) in patent map series edited by Patent Office).

As a resin, for example, polycarbonate resin is used. However, any other resin may be used so far as the resin is a material suitable for forming the movable body and a material capable of uniformly or equally dispersing the carbon nanotube.

A rate of carbon nanotube particle or powder dispersed in a resin may arbitrarily be selected in accordance with a property to be provided by the movable body so far as the conductive region (portion) and the nonconductive region (portion) can be formed into the integral movable body. From the view point of conductivity, particularly, at the conductive region (portion) constituted by dispersing the conductive carbon nanotube, it is preferable that the rate of the carbon nanotube is high. Meanwhile, from the view point of mechanical strength, when there is a concern that when the rate of the carbon nanotube is high, integration by the resin as the base material is liable to deteriorate, there is substantially an upper limit in the rate of blending the carbon nanotube in accordance with a kind of a movable member and a kind of the resin or the like. Meanwhile, typically, not only the carbon nanotube is provided with high mechanical strength but also the carbon nanotube per se is provided with elasticity and therefore, by dispersing the carbon nanotube into the resin, the mechanical strength or elasticity can be increased. Therefore, from the view point of the mechanical property, there can be a lower limit in the rate of the carbon nanotube in accordance with a kind of the composite electric part, a kind of the resin or the like. The upper limit and the lower limit, that is, the preferable range can be made to differ in accordance with the kind of the composite electric part, the kind of the resin or the like.

Further, instead of achieving integral formation of the nonconductive main body portion and the conductive portion by the resin as the base material, there may be constructed a constitution in which initial molding of the movable body is carried out by using an organic material operating as a binder and thereafter, by substantially burning off the binder portion by thermal decomposition, vaporization or the like by heating, the carbon nanotube is substantially burnt solidly to thereby form a molded product having a high rate or purity of the carbon nanotube. In this case, for example, a residue by burning off is made to mutually couple the carbon nanotubes. However, when the carbon nanotubes can mutually be coupled by a desired strength in accordance with use of the composite electric part, the residue or the like may actually be dispensed with.

As has been explained with regard to probe, the position detecting apparatus typically detects that the conductive portion or the nonconductive portion of the movable body reaches the detected region, however, depending on cases, there may be constructed a constitution in which the position detecting apparatus detects that the conductive portion or the nonconductive portion passes through the detected region. Further, the position detecting apparatus may simply detect or sense that the conductive portion or the nonconductive portion reaches the detected region or instead thereof, a detecting system including the probe is connected to an electric drive system such that other processing can be carried out caused by detection or sensing, for example, current can be made to flow or voltage can be applied to other portion in accordance with the detection or sensing.

According to the position detecting apparatus of the invention, so far as the conductive portion and the nonconductive portion can be identified, as described above, the probe may be constructed by any constitution, however, according to the position detecting apparatus of the invention, typically, the probe includes at least a single piece of conductive contact piece brought into contact with a surface of the movable body, further typically, the probe includes a pair of conductive contact pieces brought into contact with the surface of the movable body.

In this case, that is, when the probe includes the conductive contact piece, according to the position detecting apparatus of the invention, basically, the movable body is “constituted by integrally molding the conductive portion including conductive carbon nanotube and the nonconductive portion including nonconductive carbon nanotube” and therefore, a concern of causing a stepped difference or the like at a boundary between a surface portion of the conductive portion and a surface portion of the nonconductive portion in the surface of the movable body in contact with the conductive contact piece of the probe, can be restrained to minimum and therefore, even when speed of moving the movable body relative to the probe is large, there is rarely a concern that the conductive contact piece of the probe is jumped, or dropped and bounced by the surface of the movable body at the boundary and the conductive contact piece can be maintained in a stable contact state. Further, the movable body can be integrally molded by, for example, so-to-speak two colors or multiple colors injection molding or the like and therefore, a size and a position of the conductive surface portion in the nonconductive surface portion or the nonconductive surface portion in the conductive surface portion can accurately be formed.

Further, since both of the conductive portion and the nonconductive portion of the movable body include carbon nanotube, mechanical properties of the conductive portion and the nonconductive portion of the movable body are similar to each other by reflecting properties provided by carbon nanotube, for example, mechanical strength (rupture limit), elasticity of spring property and the like can similarly be promoted. As a result, there is rarely a concern that a contact state of the conductive contact piece of the probe is significantly varied at a boundary between the surface portion of the conductive portion and the surface of the nonconductive portion and the contact state of the contact piece can stably be maintained. Further, not only predetermined detection by the probe can firmly be carried out but also a concern that a contact portion or a supporting base portion of the probe is damaged or deteriorated by impact on the probe at the stepped difference, can be restrained to a minimum.

When the probe is constituted by a pair of the conductive contact pieces, the pair of conductive contact pieces may be constituted to be brought into contact with a common surface portion in the total surface of the movable body or may be constituted to be brought into contact with different surface portions. In the former case, the common surface portion in contact with the pair of probes is provided with a surface portion (exposed portion) of the conductive portion and a surface portion (exposed portion) of the nonconductive portion. With regard to respectives of the other surface portions, either one of the conductive portion and the nonconductive portion may be exposed, or both of the conductive portion and the nonconductive portion may be exposed and whether the conductive portion or the nonconductive portion is exposed to the other surface portions may pertinently be selected in consideration of a property desired for the movable body in view of the role of the movable body, easiness of fabrication or fabrication cost. In the latter case, in accordance with a way of movement of the movable body, the surface in contact with the probe may be selected. When the movable body comprises a rotating body in a shape of a circular plate, respectives of the pair of probes may be constituted to be brought into contact with an end face on the opposed side of the rotating body in the circular plate shape or may be constituted such that one of the probes is brought into contact with the peripheral face.

In this case, although the front end portion of the conductive contact piece of the probe is typically pressed elastically to the surface of the movable body, so far as contact between the front end of the conductive contact piece of the probe and the surface of the movable body can be ensured, the front end and the surface may be brought into contact with each other by other means. Further, for elastically pressing the conductive contact piece of the probe to the surface of the movable body, the conductive contact piece per se of the probe may be elastically deformable or the conductive contact piece of the probe may be pressed to the surface of the movable body by elastic means.

The movable body may be constructed by any moving constitution so far as the conductive region and the nonconductive region of the movable body pass through the detected region, for example, there may be constructed a constitution reciprocally moving, a rotating constitution (rotating body), or a constitution circulating along a complicated path, or a constitution for carrying out other kind of movement.

When the movable body is constituted by a rotating body, the surface of the movable body in contact with the probe may be a peripheral face of the movable body or a face intersecting with the rotational axis line of the movable body. In the latter case, although the face is typically constituted by a plane orthogonal to the rotational axis line, depending on cases, the face may be constituted by smooth recesses and projections or waviness.

When the probe is constituted by the pair of contact pieces, the pair of contact pieces may be brought into contact with the same face of the movable body or may be brought into contact with different faces thereof. For example, when the movable body is constituted by a rotating body, both of the pair of contact pieces may be brought into contact with a peripheral face of the rotating body, or brought into contact with either one of end faces, either of the pair of contact pieces may be brought into contact with the peripheral face and other thereof may be brought into contact with an end face intersecting with the rotational axis line, or one of the pair of contact pieces may be brought into contact with one end face of the rotating body and other contact face may be brought into contact with other end face thereof.

When the probe is constituted by a pair of contact pieces and the rotating body is constituted by a wheel, the contact pieces can be brought into contact with a common end face or end faces on opposed sides. In this case, the wheel is constituted by integrally molding a portion including carbon nanotube and therefore, the wheel can comparatively be light and can be provided with high mechanical strength. Therefore, the wheel can easily be rotated at high speed on one hand and can transmit large power or force on the other hand. Further, the wheel is constituted by integrally molding the conductive portion including conductive carbon nanotube and the nonconductive portion including nonconductive carbon nanotube and therefore, even when the wheel is rotated at high speed or applied with large load, there is rarely a concern of actually causing excessive deformation or causing permanent deformation.

For example, when the wheel is constituted by a wheel for driving a hand of a timepiece, as described above, for example, by so-to-speak two colors or multiple colors injection molding or the like, the wheel can integrally be molded and the size and the position of the conductive surface portion in the conductive surface portion or the nonconductive surface portion in the conductive surface portion can accurately be formed and therefore, the position of the hand can be set accurately and stably over a long period of time.

### BRIEF DESCRIPTION OF THE SEVERAL VIEWS OF THE DRAWINGS

A preferred form of the present invention is illustrated in the accompanying drawings in which:

FIG. 1 illustrate views for explaining an electronic timepiece having a hand position detecting apparatus according to a preferable embodiment of the invention in which FIG. 1A is a block diagram of an example of a radio wave correcting mechanism and FIG. 1B is an explanatory vertical sectional view of a hand position detecting portion (sectional view taken along a line IB-IB of FIG. 2);

FIG. 2 is an explanatory plane view of a second wheel viewing FIG. 1 along a line II-II;

FIG. 3 show modified examples of a second pinion of FIG. 1 in which FIG. 3A is an explanatory sectional view taken along a line IIIA-IIIA of FIG. 3B with regard to a vertical section similar to FIG. 1B. FIG. 3B is an explanatory sectional view taken along a line IIIB-IIIB of FIG. 3A;

FIG. 4 show other modified examples of the second pinion of FIG. 1 in which FIG. 4A is an explanatory sectional view taken along a line IVA-IVA of FIG. 4B. FIG. 4B is an explanatory sectional view taken along a line IVB-IVB of FIG. 4A; and

FIG. 5 show still other modified examples of the second pinion of FIG. 1 in which FIG. 5A is an explanatory sectional view taken along a line VA-VA of FIG. 5B. FIG. 5B is an explanatory sectional view taken along lines, VB-VB of FIGS. 5A and 5C. FIG. 5C is an explanatory sectional view taken long a line VC-VC of FIG. 5B.

### DETAILED DESCRIPTION OF THE PREFERRED EMBODIMENTS

An explanation will be given of several modes for carrying out the invention based on preferable embodiments shown in the attached drawings.

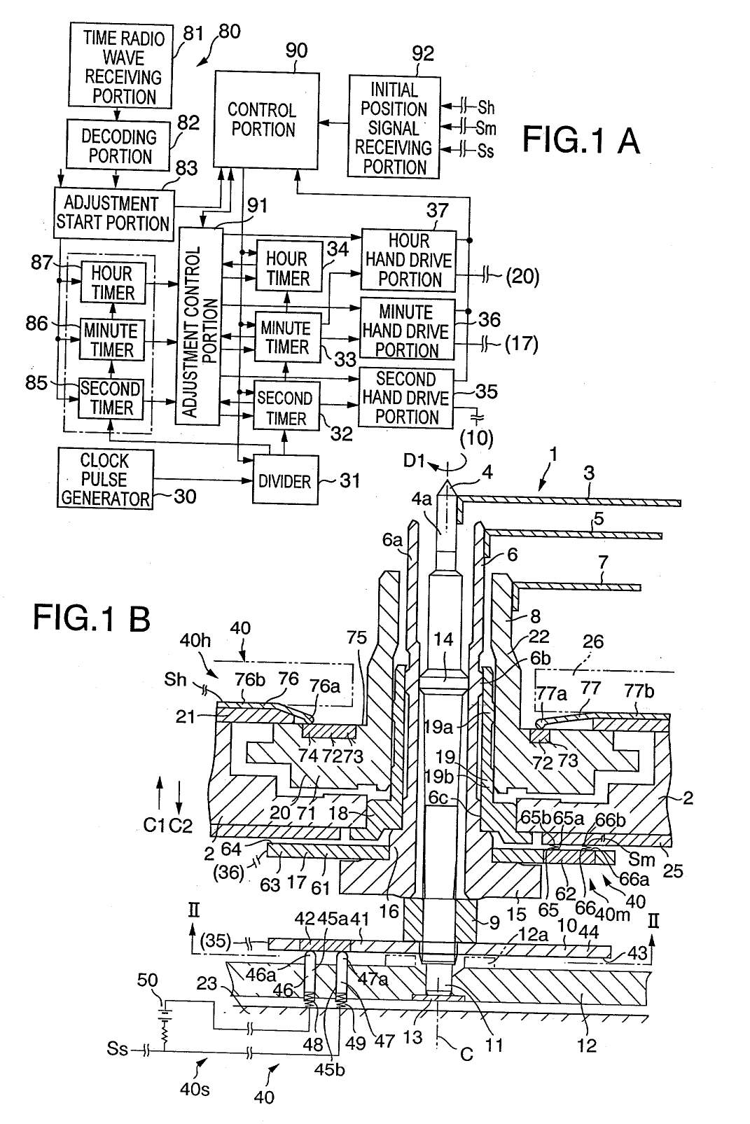

FIG. 1 show related portions of an example of an electronic timepiece 1 of a time correcting type by radio wave using a hand position detecting apparatus 40 constituting a position detecting apparatus according to a preferable embodiment of the invention. In this case, the hand position detecting apparatus 40 generally refers to three kinds of hand position detecting apparatus of a second hand initial position detecting apparatus 40s, a minute hand initial position detecting apparatus 40m and an hour hand initial position detecting apparatus 40h and may detect only one kind of a hand position of these depending on use thereof. In FIG. 1B, numeral 2 designates a main plate stationarily mounted or fixed to a 21 timepiece main body portion including an external case (not illustrated) of the timepiece and the timepiece 1 is provided with a second pinion 4 attached with a second hand 3 at a front end portion thereof, a center pinion 6 attached with a minute hand 5 at a front end portion thereof and an hour wheel 8 attached with an hour hand 7 at a front end portion thereof. Notation C designates a rotational center axis. A base end portion of a core portion 4a of the second pinion 4 is formed with a pinion portion 9 and attached with a second wheel 10. The core portion 4a of the second pinion 4 is supported by a train wheel bridge 12 and a thrust bearing portion 13 of the train wheel bridge 12 at a base end 11 thereof and is brought into sliding contact with a cylindrical core portion 6a of the center pinion 6 by an upper shaft portion 14 in a shape of an abacus bead having an enlarged diameter at a middle portion thereof. The train wheel bridge 12 may be provided with a ring-like projected portion for supporting the second wheel 10 at an inner peripheral edge thereof as shown by an imaginary line 12a. A base end side of the core portion 6a of the center pinion 6 is formed with a pinion portion 15 and a strike-in portion 16 having an enlarged diameter of the center pinion 6 is attachedly mounted to a center wheel 17. The center pinion 6 is brought into sliding contact with an opposed end face of the pinion portion 9 of the second pinion 4 at an end face thereof on the base end side. There is arranged a center pipe 19 fittedly mounted to a hole of the main plate 2 at a flange portion 18 thereof between the center pinion 6 and the hour wheel 8. The center pipe 19 slidingly rotatably supports enlarged barrel portions 6b and 6c of the cylindrical core 6a of the center pinion 6 at an inner peripheral face thereof and slidingly rotatably supports the hour wheel 8 by enlarged barrel portions 19a and 19b at an outer periphery thereof. Detachment of a rear wheel portion 20 of the hour wheel 8 in a front end direction C1 is restricted by an hour wheel holder 21 fixed to the main plate 2.

According to the electronic timepiece 1, as shown by, for example, FIG. 1A, a second pulse is generated by dividing a clock pulse from a clock pulse generator 30 by a divider 31, the second pulse is counted by a second timer 32, a minute pulse generated when the second timer 32 is reset to zero at every 60 counts, is counted by a minute timer 33 and a time (hour) pulse generated when the minute timer 33 is reset to zero at every 60 counts, is counted by a time (hour) timer 34. The second timer 32 operates a second hand drive portion 35 by generating a second hand pulse at every count to thereby rotate the second hand 3 in D1 direction by respective 6 degrees via the second wheel 10 and the second pinion 4 and the minute timer 33 operates a minute hand drive portion 36 by generating a minute hand pulse at every count to thereby rotate the minute hand 5 in D1 direction via the center wheel 17 and the center pinion 6. The minute timer 33 operates an hour hand drive portion 37 by generating an hour hand pulse at, for example, every 10 counts to thereby rotate the hour hand 7 in D1 direction by respective 5 degrees via the gear wheel portion 20 of the hour wheel 8 and an hour main portion 22.

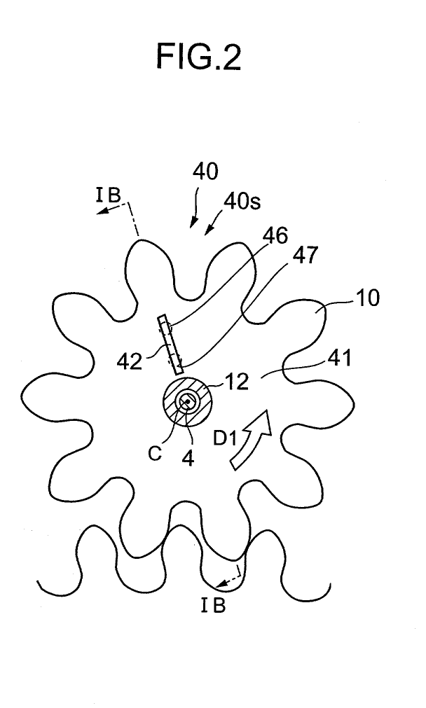

As shown by FIG. 1B and FIG. 2, the second wheel 10 is provided with a nonconductive portion 41 occupying a most region of the wheel 10 and a conductive portion 42 extended along a radius direction of the wheel 10. Incidentally, in FIG. 2, a tooth of the second wheel 10 and the like are shown to be large by exaggeration. When a diameter of the second wheel 10 is about 3 mm and a thickness thereof is about 0.1 mm through about 0.3 mm, a length of the conductive portion 42 is, for example, about 1 mm and a width thereof is about 0.1 mm. Naturally, the size is simply an example and at least one of the diameter and the thickness of the rotating body and the length and the width of the conductive portion, may be larger or may be smaller in accordance with the size of the timepiece 1 and a role to be provided by the rotating body. Further, the conductive portion 42 may be extended over a total length in the radius direction of the second wheel 10 and in that case, an outer side end portion in the radius direction of the conductive portion 42 may be disposed at a top portion of a tooth formed at a peripheral face of the wheel 10, maybe disposed at a valley portion thereof, may be disposed at an inclined face thereof or may be expanded over a plurality of teeth. According to the example, the conductive portion 42 is extended over a total thickness of the second wheel 10 with regard to the thickness direction and is provided with the thickness coinciding with a thickness of the second wheel 10. Therefore, the conductive portion 42 is exposed at both of a base end side surface 43 and a front end side surface 44 of the second wheel 10. The nonconductive portion 41 is constituted by dispersing, for example, about several tens % of nonconductive carbon nanotube particles substantially uniformly in a resin material and also the conductive portion 42 is constituted by dispersing, for example, about several tens % of conductive carbon nanotube particles substantially uniformly in a resin material. The second wheel 10 comprising the nonconductive portion 41 and the conductive portion 42, is formed by integral molding by so-to-speak two colors injection molding by using the resin row material dispersed with the nonconductive carbon nanotubes and the resin low material dispersed with the nonconductive carbon nanotubes.

The train wheel bridge 12 opposed to the base end side surface 43 of the second wheel 10, is formed with a pair of axial direction holes 45a and 45b and the holes 45a and 45b are arranged with conductive pins 46 and 47 constituting a pair of conduct pieces slidably in longitudinal directions thereof. The pins 46 and 47 are pressed in C1 direction toward front end sides thereof by conductive compression springs 48 and 49 disposed between a circuit block 23 stationarily mounted and fixed to an exterior or the main plate 2 or the like of the timepiece 1 and the pins 46 and 47. Although the springs 48 and 49 may be brought into press contact with or fixed to base end portions of the pins 46 and 47 in a solid rod-like shape, the pins 46 and 47 are preferably constituted by cylindrical bodies each having a closed front end and an opened base end and the front ends of the springs 48 and 49 are fitted into the cylindrical pins 46 and 47 and are brought into contact with the pins 46 and 47 at inner faces of cylinders. The pins 46 and 47 fall in a range of capable of being opposed to the conductive portion 42 in view from a radius direction centering on the central axis line C and when the conductive portion 42 is rotated in D1 direction in accordance with rotation of the second wheel 10, in the case in which the conductive portion 42 reaches a rotational position opposed to the pins 46 and 47, that is, a detected position, more in details, in the case in which front end portion 46a and 47a of the both pins 46 and 47 are brought into contact with a front edge in the rotational direction D1 of the conductive portion 42, the front end portions 46a and 47a of the pins 46 and 47 are conducted by operation of closing a contact switch.

Voltage of a power source 50 is applied between the springs 48 and 49 of the pins 46 and 47, every time of conducting the front end portions 46a and 47a of the pins 46 and 47 by the conductive portion 42, presence of the conductive portion 42 in a detected region (the conductive portion 42 is brought into the detected region or is passing through the detected region), is outputted by a detection signal Ss. In this case, typically, for example, the second wheel 10 is positioned such that when the second hand 3 is exactly disposed at the zero position or the initial position, a front edge of the conductive portion 42 in D1 direction is brought into contact with the front end portions 46a and 47a of the pins 46 and 47. Naturally, instead thereof, that the conductive portion 42 comes out from the detected region (passing of the detected region is finished, that is, that either of the pins 46 and 47 leaves from a rear edge in D1 direction) may be detected. When the width of the conductive portion 42 is sufficiently small, in positioning the second wheel 10, a position thereof in the width direction in contact with the pins 46 and 47 may be disregarded. In the above-described, the second hand initial position detecting apparatus 40s includes the second wheel 10 constituting a movable body having the conductive portion 42 and the nonconductive portion 41 and the pins 46 and 47 constituting a probe operated as the contact switch in cooperation with the conductive portion 42 of the second wheel 10 and further includes the power source 50 and the like in this example.

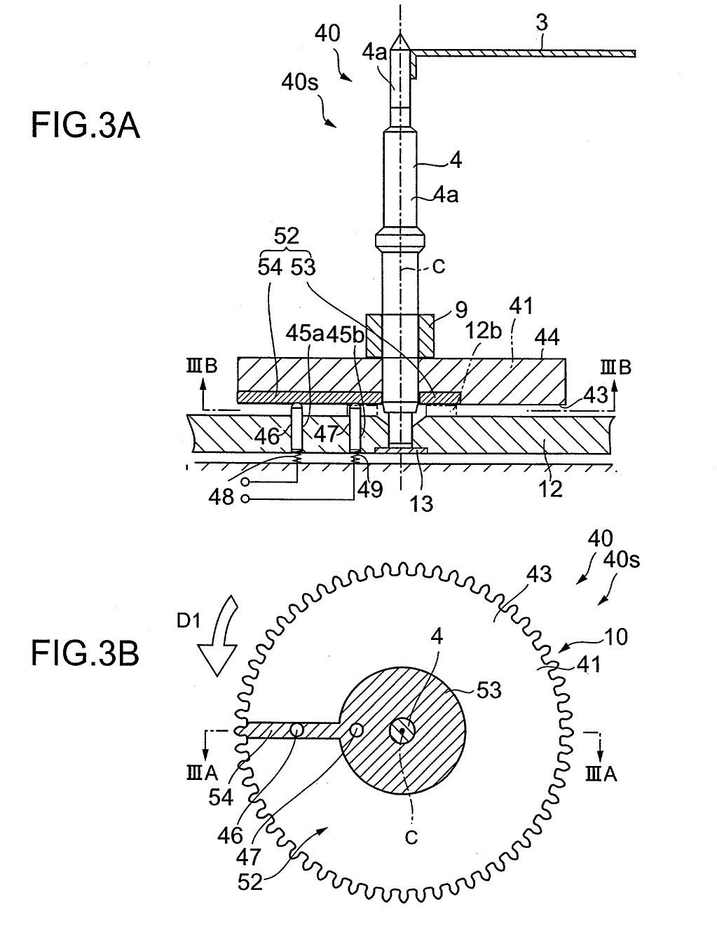

Further, as shown by FIG. 3, instead of causing or releasing contact and conduction between the pins 46 and 47 and the conductive portion of the second wheel 10 substantially simultaneously, the second hand initial position detecting apparatus 40s may be constituted such that a conductive portion 52 is constituted by a circular or a ring-like central portion 53 and a radius direction extended portion 54 extended in a radius direction from an outer peripheral face of the ring-like central portion 53 such that one pin 47 of the pins 46 and 47 is maintained in a state of being brought into contact with and conducted with the conductive portion 52 and other pin 46 is brought into contact with and conducted with the conductive portion 52 of the second wheel only when the second wheel 10 is disposed at a predetermined rotational position (for example, zero position or initial position). In this case, different from the example shown in FIG. 1 and FIG. 2, the position of the train wheel bridge 12 may be determined such that in place of positions in D1 direction of the two pins 46 and 47, that is, positions in D1 direction of the two holes 45a and 45b, positioning of the one pin 46, that is, the position in D1 direction of the hole 45a of the train wheel bridge 12, is disposed at a predetermined position relative to the initial position of the second hand 3 and therefore, positioning is liable to be carried out easily and accurately. In this example, the pin 47 is always brought into contact with the central ring-like portion 53 of the conductive portion 52 and therefore, the pin 47 may not be regarded as the probe. For example, when a projection 12b similar to the ring-like supporting portion or the ring-like projection 12a shown by the imaginary line at the inner peripheral edge of the train wheel bridge 12 in FIG. 1B, is formed integrally with the train wheel bridge 12 per se, the ring-like projection 12b is used as a conductive pass forming member in place of the pin 47 (naturally, there is formed a conductive pass connected to an external lead-out terminal is formed at a surface or an inner portion of the train wheel bridge 12), thereby, the hand position detecting apparatus 40s can be made to carry out similar operation. In this case, the hand position detecting apparatus 40s is provided with the contact piece or pin 46 constituting a single probe and the conductive supporter 12b in place of the pair of probes 46 and 47. Further, according to the example, the conductive portion 52 is exposed at the base end side surface 43 of the second wheel 10 and is extended up to a middle in the thickness direction of the second wheel 10. Naturally, instead thereof, the conductive portion 52 may be extended to a total in the thickness direction. Further, a radius direction outer end portion of the radius direction extended portion 54 may be disposed on an inner side in the radius direction of an outer peripheral teeth portion instead of being extended to an outer periphery of the second wheel 10, further, there may be constructed a constitution in which the ring-like portion 53 is disposed on an outer side in the radius direction of the radius direction extended portion 54 and is always brought into contact with the pin 46 and the radius direction extended portion 54 extended inwardly in the radius direction from an inner peripheral edge of the ring-like portion 53, is brought into contact with the pin 47 at a predetermined rotational position. Further, in the case of the example of FIG. 3, with regard to the rotational direction D1 of the second wheel 10, the pins 46 and 47 may be disposed at arbitrary relative positions instead of being disposed at the same position (on a straight line in view from the radius direction). Further, according to the example of FIG. 3, the radius direction extended portion 54 maybe inclined to the radius direction, may be formed in a curved shape in place of the linear shape, or the width may be varied according to the position in the longitudinal direction so far as a rotational position thereof starting to be brought into contact with the pin 46 can be set to a predetermined position.

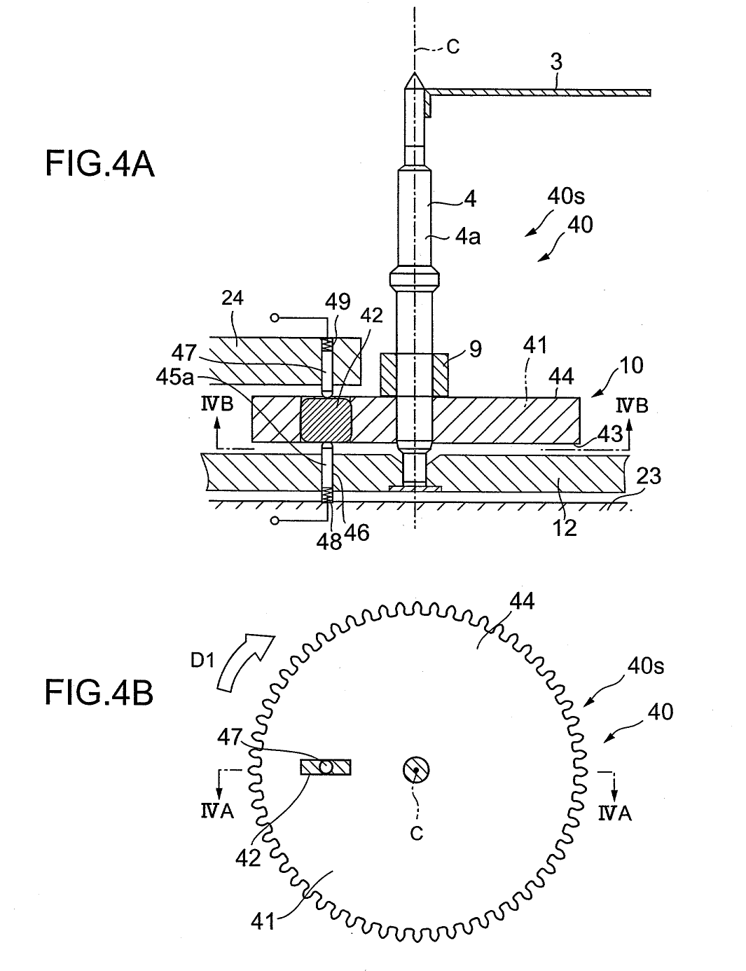

Further, in the second hand initial position detecting apparatus 40s, instead of arranging a pair of contact pieces to be opposed to the common end face 43 (for example, examples of FIGS. 1 and 2) or 44 of the second wheel 10, one pin (for example, pin 47) of the pair of pins 46 and 47 constituting the pair of contact pieces may be brought into contact with the conductive portion 42 at the front end side end face 44 of the second wheel 10 as shown by FIG. 4. In FIG. 4, the pin 47 is supported by a supporter 24 including an auxiliary circuit block similar to a circuit block 23 via the conductive compression spring 49. In the case of the example, even when the diameter of the second wheel 10 is comparatively small, the respective pins 46 and 47 can firmly be supported and the respective pins 46 and 47 can be positioned independently from each other within a range of the width of the conductive portion 42 and therefore, positioning is liable to be carried out easily. Although in this case, the pin 47 is arranged typically to be exactly opposed to the pin 46 via the train wheel bridge 12, the pins 47 and 46 may be shifted from each other relatively in respective directions within a range of the length in the diameter direction and a length in the rotational direction, that is, the width of the conductive portion 42. Depending on cases, the conductive portion 42 may be inclined in view from the thickness direction.

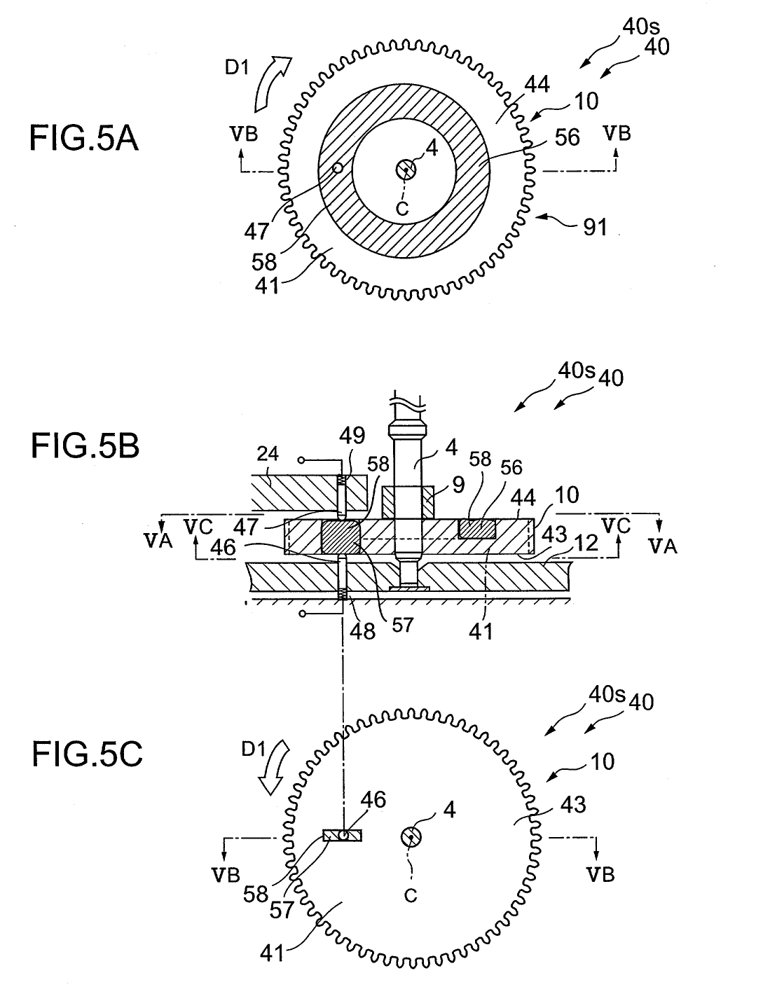

Further, as shown by FIG. 5, the second hand initial position detecting apparatus 40s may be constructed by a constitution comprising by combining modifications as shown by FIG. 3 and FIG. 4. That is, there may be constructed a constitution in which similar to the modified example of FIG. 4, the one pin 47 is supported by the supporter 24 via the conductive compression spring 49 on a side opposed to the front end side end face 44 of the second wheel 10, further, similar to the modified example of FIG. 3, a conductive portion 56 which is always brought into contact with the one pin 47, is constituted such that a shape of an exposed portion thereof at the front end side end face 44 is constituted by a circular plate shape or a ring-like shape and a conductive portion 57 capable of being brought into contact with another pin 46 is, constituted by a linear shape or a band-like shape such that an exposed shape thereof at the base end side end face 43 is slender and extended in the radius direction. In this case, although a conductive portion 58 constituted by the secondary conductive portions 56 and 57 are formed at positions and by shapes in view from the thickness direction of the second wheel 10 as shown by, for example, FIG. 5, from the view point of easiness of fabrication, when desired, the positions and the shapes may not be constituted in one row in the thickness direction.

Referring back to FIG. 1B, similar to the second wheel 10, also the center wheel 17 is constituted by an integrally molded product of a nonconductive portion 61 including nonconductive carbon nanotube and a conductive portion 62 including conductive carbon nanotube. Similar to the conductive portion 42 of the second wheel 10, the conductive portion 62 of the center wheel 17 is slender and extended in the radius direction and is exposed at end faces 63 and 64 at both ends in the thickness direction. According to the example, a pair of contact pieces are constituted by conductive springs 65 and 66 per se such as coil springs made of a metal and the springs 65 and 66 are brought into contact with the front end side end face 64 of the second wheel 17 at front ends 65a and 66a thereof and are brought into contact with pads or terminal portions in correspondence with a printed wiring of a circuit board 25 fixed to the main plate 2 at base ends 65b and 66b thereof. The base ends 65b and 66b may be fixedly attached to corresponding terminal portions of the circuit board 25. Further, in order to restrain the front ends 65a and 66a of the springs 65 and 66 from being shifted or bent in a direction intersecting with C1 and C2 directions by rotation of the center wheel 17 in D1 direction, there may be constructed a constitution in which contact portions are formed at front ends of the coil springs and there may be provided desired restraining and guiding means such as shafts penetrating the coil springs from the contact portions and extended in C1 direction and slidably moved in C1 and C2 directions at inside of the board 25. Further, in the case of a resin dispersed with carbon nanotube at a comparatively high density, having a comparatively high hardness and comparatively small friction, such a restraining and guiding means may be dispensed with. According to the example, the springs 65 and 65 per se constitute the contact pieces and therefore, a gap between the circuit board 25 and the center wheel 17 can be reduced. Voltage is applied between the conductive springs 65 and 66 by a power source circuit (not illustrated) similar to the power source circuit 50 for the conductive springs 48 and 49 and electricity is conducted therebetween only when the front end portions 65a and 66a of the conductive springs 65 and 66 are brought into contact with the conductive portion 62 of the center wheel 17 and conducted by the conductive portion 62. The electricity conductive portion is typically selected at a position at which the minute hand 5 is disposed at the zero position or the initial position. Therefore, when the minute hand 5 returns to the initial position, the conductive portion 62 is detected by the conductive spring 65 and 66 and a minute hand initial position detecting signal Sm is outputted.

Further, with regard to shapes, arrangements and the like of the conductive portion 62 and the contact pieces 65 and 66, similar to constitutions explained in reference to FIG. 1 through FIG. 5 with regard to the conductive portions 42, 52 and 58 of the second wheel 10 and the contact pieces 46 and 47, desired arbitrary modes can be adopted (further, there may be adopted shapes and arrangements similar to shapes and arrangements of the conductive portion 62 of the center wheel 17 and the contact pieces 65 and 66 for the conductive portions 42, 52 and 58 of the second wheel 10 and the contact pieces 46 and 47). Naturally, the contact pieces 65 and 66 may be constituted by pins or the like deviated by separate springs similar to the contact pieces 46 and 47.

Further, similarly, also the gear wheel portion 20 of the hour wheel 8 is constituted by an integrally molded product of a nonconductive portion 71 including nonconductive carbon nanotube and the conductive portion 72 including conductive carbon nanotube. A total of the hour wheel 8 may be constituted by an integrally molded product, or the gear wheel portion 20 in the hour wheel 8 may be constituted by an integrally molded product and the gear wheel portion 20 may be fixed to the hour main body portion 22 of the hour wheel 8. The conductive portion 72 of the gear wheel portion 20 of the hour wheel 8 is provided with a central ring-like portion 73 and a radius direction extended portion 74 slenderly extended from an outer peripheral edge of the ring-like portion 73 outwardly in the radius direction similar to the conductive portion 52 of the second wheel 10 shown in, for example, FIG. 3 and the conductive portion 72 is formed at a portion in the thickness direction of the gear wheel portion 20 to expose at one end face 75, that is, the front end side end face 75 of the gear wheel portion 20. According to the example, a pair of contact pieces are constituted by conductive leaf springs 76 and 77 and the springs 76 and 77 are brought into contact with the front end side end face 75 of the gear wheel portion 20 at front end portions 76a and 77a thereof projected in the dome-like shape, supported and fixed between the hour wheel holder 21 fixed to the main plate 2 and a circuit board or a circuit block 26 at base end portions 76b and 77b thereof and are brought into contact with corresponding pads or terminal portions of a printed wiring of the circuit board 26 at the base end portions 76b and 77b. The base end portions 76b and 77b may be fixedly attached to corresponding terminal portions of the circuit board 26. According to the example, the front end portion 77b of the spring 77 is disposed more proximately to the central axis line C than the front end portion 76b of the spring 76 and is always brought into contact with the ring-like central portion 73 of the conductive portion 72 and the front end portion 76b of the spring 76 disposed on an outer side in the radius direction can be brought into contact with slender radius direction extended portion 74 in accordance with rotation of the gear wheel portion 20 in D1 direction. Voltage is applied between the conductive springs 76 and 77 by a power source circuit (not illustrated) similar to the power source circuit 50 for the conductive springs 48 and 49 and electricity is conducted therebetween only when both of the front end portions 76a and 77a of the conductive springs 76 and 77 are brought into contact with the conductive portion 72 of the gear wheel portion 20 and conducted by the conductive portion 72. Also the electricity conductive portion is typically selected to a position at which the hour hand 7 is disposed at the zero portion or the initial position. Therefore, when the hour hand 7 returns to the initial position, the conductive portion 72 is detected by the conductive springs 76 and 77 and an hour hand initial position detecting signal Sh is outputted.

Further, also shapes, arrangements and the like of the conductive portion 72 and the contact pieces 76 and 77 can adopt desired modes similar to constitutions explained with regard to the conductive portions 42, 52 and 58 of the second wheel 10 and the contact pieces 46 and 47 or similar to constitutions explained with regard to the center wheel 17 (conversely, there may be adopted shapes and arrangements similar to shapes and arrangements of the conductive portions 72 and the contact pieces 76 and 77 for the conductive portions 42, 52 and 58 of the second wheel 10 and the contact pieces 46 and 47 or the conductive portion 62 of the center wheel 17 and the contact pieces 65 and 66). Naturally, the contact pieces 76 and 77 may be constituted by pins or the like shifted by separate springs similar to the contact pieces 46 and 47.

According to the electronic timepiece 1, when the hour hand 7, the minute hand 5 and the second hand 3 are disposed at or reach the zero positions or the initial positions, that is, when positions of the hands 7, 5 and 3 are disposed at, for example, 0 o'clock 00 minute 00 second, the zero position (feedback) detection signals Sh, Sm and Ss of the hands are outputted from the respective hand position detecting portions. Naturally, as the initial positions, previously determined arbitrary positions can be selected.

Further, constitution and operation of a time correcting mechanism by radio wave explained below, are exemplified for specifically explaining operation of the hand position detecting apparatus 40 and in the electronic timepiece 1 having the hand position detecting apparatus 40, the constitution and the operation of the time correcting mechanism by radio wave may be any other constitution and operation. Further, although not clearly described in the previous explanation, drive mechanisms and drive operation of the hands 3, 5 and 7 by the timers 32, 33 and 34, further, arrangements, ways of driving and the like of the wheels 10, 17 and 20 may be any thereof other than the exemplified.

As shown by, for example, a block diagram of FIG. 1A, a radio wave correcting portion 80 of the timepiece 1 is provided with a time radio wave receiving portion 81, a decoding portion 82 for decoding time radio wave received by the radio wave receiving portion 81 and sampling time information, an adjustment start portion 83 and a current time holding portion 84. When current time information from the decoding portion 82 coincides with previously set time (for example, a.m. 2 o'clock 00 minute 00 second corresponding to sleeping), the adjustment start portion 83 gives the time information to the current time holding portion 84 and gives an adjustment start signal to a control portion 90 to thereby start adjusting operation. The current time holding portion 84 is provided with a second timer 85, a minute timer 86 and an hour timer 87 indicating current time.

When the adjustment start signal is received, the control portion 90 gives an adjustment start signal to the divider 31 to thereby start supplying a second pulse from the divider 31 to the current time holding portion 84, makes the second timer 85, the minute timer 86 and the hour timer 87 of the current time holding portion 84 start counting current time, stops supplying the second pulse from the divider 31 to the second timer 32, further, resets the second timer 32, the minute timer 33 and the hour timer 34 to zero and stops control of operating the second hand drive portion 35 and the minute hand drive portion 36 and the hour hand drive portion 37 by the second timer 32 and the minute timer 33.

Further, the control portion 90 gives a fast feed control start signal to the initial positions of the hands 3, 5 and 4, to an adjustment control portion 91 and the adjustment control portion 91 gives the fast feed drive start signal to the initial position of the hands, 3, 5 and 7 to the second hand drive portion 35, the minute hand drive portion 36 and the hour hand drive portion 37. The fast feed drive start signal may be a signal having a pulse width or the like in accordance with differences between content (hold values) of the second timer 32, the minute timer 33 and the hour timer 34 before resetting and reset values (initial value). The second hand drive portion 35, the minute hand drive portion 36 and the hour hand drive portion 37 fast rotate the second hand 3, the minute hand 5 and the hour hand 7 via the second wheel 10, the center wheel 17 and the gear wheel portion 20 of the hour wheel 8 related thereto. When respectives of the second hand 3, the minute hand 5 and the hour hand 7 reach the initial positions, the second hand initial position detection signal Ss is generated from the second hand initial position detecting apparatus 40s by conducting the pins 46 and 47 by the conductive portion 42, the minute hand initial position detection signal Sm is generated from the minute hand initial position detecting apparatus 40m by conducting the conductive springs 65 and 66 by the conductive portion 62 and the hour hand initial position detection signal Sh is generated from the hour hand initial position detecting apparatus 40h by conducting the conductive leaf springs 76 and 77 by the conductive portion 72.

When respectives of the second hand initial position detection signal Ss, the minute hand initial position detection signal Sm and the hour hand initial position detection signal Sh are given from an initial position signal receiving portion 92 to the control portion 90, the control portion 90 stops respective drive operation of related hand drive portions, that is, the second hand drive portion 35, the minute hand drive portion 36 and the hour hand drive portion 37 related thereto by the adjustment control portion 91.

When information that all of the second hand initial position detection signal Ss, the minute hand initial position detection signal Sm and the hour hand initial position detection signal Sh have been detected, is given to the control portion 90 and operation of driving and stopping of the drive portions 35, 36 and 37 by the adjustment control portion 91 have been finished, the control portion 90 makes adjustment control portion 91 carry out adjusting operation. The adjustment control portion 91 compares content of the second timer 32 for indication (initially, for example, 0)and content of the second timer 85 for holding current time, fast feeds the second hand 3 by the second hand drive portion 35 via the second wheel 10 in accordance with the reference and makes the content of the second timer 32 for indication with the content of the second timer 85 for holding current time. Also with regard to “minute” and “hour”, similarly, the adjustment control portion 91 compares content of the timer 33 for indication (initially, for example, 0) and content of the minute timer 86 for holding current time, fast feeds the second hand 5 by the minute hand drive portion 36 via the center wheel 17 in accordance with the difference, makes the content of the timer 33 for indication coincide with the content of the timer 86 for holding current time at the time point, compares content (initially, for example, 0) of the hour timer 34 for indication with content of the hour timer 87 for holding current time, fast feeds the hour hand 7 by the hour hand drive portion 37 via the gear wheel portion 20 of the hour wheel 8 in accordance with the difference and makes the content of the timer 34 for indication coincide with the content of the hour timer 87 for holding current time. When a signal of finishing fast feed drive is given from the drive portions 35, 36 and 37 to the adjustment control portion 91 via the control portion 90, the adjustment control portion 91 repeats comparison between the contents of the timers 32, 33 and 34 for indication and the contents of the timers 85 and 86 and 87 for holding current time and adjustment of the differences until the differences are eliminated. When the contents of the timers 32, 33 and 34 for indication at the time point of finishing fast feed drive, coincide with the contents of the timers 85 and 86 and 87 for holding current time, the control portion 90 receives the adjustment control finish signal from the adjustment control portion 91, starts supplying the second pulse from the divider 31 to the second timer 32 for indication, restarts supplying operation control signals from the timers 32, 33 and 34 for indication to the related drive portions 35, 36 and 37, and stops supplying the second pulse from the divider 31 to the second timer 85 for holding current time.

In the above-described, a point to which attention is to be attracted as the embodiment of the invention, resides in detection of the initial position and with regard to way of detecting current time, way of driving, way of stepping and way of fast feeding respectives of the second hands, the minute hand the hour hand and the like, the ways are exemplified simply as an example for explaining detection of the initial position and may be replaced by any other mechanisms or constitutions.

According to the timepiece 1 of the radio wave correcting type (type adjusting indicated time by radio wave) constituted as shown by FIGS. 1 through 5, the respective hand position detecting apparatus 40s, 40m and 40h for detecting that the second hand 3, the minute hand 5 and the hour hand 7 reach the initial positions, are formed by integrally molding the wheels 10, 17 and 20 constituting movable members rotated along with the respective hands 3, 5 and 7 by nonconductive portions and conductive portion, further, the conductive contact pieces constituting the probes are brought into contact with the wheels 10, 17 and 20 and therefore, conduction between the conductive contact pieces and the conductive portions and release thereof can stably be carried out for a long period of time. Further, the conductive portion and the nonconductive portion are respectively constituted by dispersing conductive and nonconductive carbon nanotubes and therefore, from a view point other than the conductivity, the conductive portion and the nonconductive portion are substantially constituted by the same material and therefore, bonding between the conductive portion and the nonconductive portion can be extremely solid and there is rarely a concern of causing a stepped difference at a boundary between the conductive portion and the nonconductive portion at a surface portion with which the contact piece is brought into contact. Further, both of the conductive portion and the nonconductive portion are constituted by a resin reinforced by carbon nanotube and therefore, mechanical strength thereof can sufficiently be high. Further, such an integral molding of the conductive portion and the nonconductive portion can be carried out by so-to-speak two colors or multiple colors injection molding and therefore, it is facilitated to comparatively accurately prescribe the position and the width of the conductive portion indicating the initial position and fabrication cost of the hand position detecting apparatus 40 can be reduced. In addition, not only the mechanical strength of the resin reinforced by the carbon nanotube becomes high but also when friction of the surface of the reinforced resin becomes low, slidability between the surface of the resin and a contact end portion of the conductive contact piece can be promoted.

Further, although according to the above-described, an explanation has been given of an example in which most of the wheel is constituted by a nonconductive portion and a portion thereof is constituted by a conductive portion, there may be constructed a constitution in which most portion thereof is constituted by the conductive portion instead of the nonconductive portion and a remaining portion thereof is constituted by the nonconductive portion instead of the conductive portion.

Further, when the movable body is constituted by the wheel, there may be constructed a constitution in which a ring-like portion of an outer periphery of the wheel including teeth is formed separately, a movable body main body on an inner side is integrally molded by a nonconductive portion and a conductive portion including nonconductive and conductive carbon nanotubes, further, for example, in the integral molding or thereafter, the ring-like teeth portion is integrated.

Although in the above-described, an explanation has been given of an example of using the hand position detecting apparatus in the electronic timepiece of the radio wave correcting type, the hand position detecting apparatus may be used for other purpose such as setting the hand to the initial portion in order to adjust the position of the hand after interchanging a battery or detecting the position of the hand for setting the hand of a stop watch to the initial position. Further, the position detecting apparatus can be used for detecting a position of an arbitrary rotating body other than the hand of the timepiece. Further, the movable body may carry out arbitrary movement such as reciprocal movement, other circulating movement or the like instead of a rotating body for carrying out rotational movement.

What is claimed is

1. A position detecting apparatus comprising:
a movable body constituted by integrally molding a conductive portion including a conductive carbon nanotube and a nonconductive portion including a nonconductive carbon nanotube; and
a probe for detecting that either one portion of the conductive portion and the nonconductive portion of the movable body is present at a detected region.

2. The position detecting apparatus according to claim 1, wherein the probe includes at least a single piece of the conductive contact piece brought into contact with a surface of the movable body.

3. The position detecting apparatus according to claim 2, wherein the probe includes a pair of the conductive contact pieces brought into contact with the surface of the movable body.

4. The position detecting apparatus according to claim 3, wherein the pair of conductive contact pieces are brought into contact with different surfaces of the movable body.

5. The position detecting apparatus according to claim 3, wherein the pair of conductive contact pieces are brought into contact with a same surface of the movable body.

6. The position detecting apparatus according to claim 1, wherein the movable body is a rotating body.

7. The position detecting apparatus according to claim 6, wherein the rotating body comprises a wheel.

8. The position detecting apparatus according to claim 7, wherein the probe is brought into contact with a face intersecting with a rotational axis line of the wheel.

9. A hand position detecting apparatus of a timepiece according to claim 1, further comprising a hand fixed to the movable body and moved along with the movable body.

10. An electronic timepiece having the hand position detecting position apparatus according to claim 9.
